(19) United States
(12) Patent Application Publication
(10) Pub. No.: US 2025/0091495 A1
(43) Pub. Date: Mar. 20, 2025

(54) SEAT ASSEMBLY & ADJUSTABLE ARMREST ASSEMBLY

(71) Applicant: Lear Corporation, Southfield, MI (US)

(72) Inventors: Minghao Yan, Shanghai (CN); Bin Lu, Shanghai (CN); Shuanghua Yang, Shanghai (CN); Xia Li, Shanghai (CN); Yue Zuo, Shanghai (CN)

(21) Appl. No.: 18/888,861

(22) Filed: Sep. 18, 2024

(30) Foreign Application Priority Data
Sep. 19, 2023 (CN) 202311212505X

(51) Int. Cl. B60N 2/75

(52) U.S. Cl. CPC B60N 2/77; B60N 2/767

(57) ABSTRACT

The present application relates to a seat assembly and an adjustable armrest assembly. An adjustable armrest assembly may include an armrest mount, an armrest, and an armrest adjuster. The armrest may be adjustably connected to the armrest mount. The armrest adjuster may be pivotably connected to the armrest and the armrest mount. The armrest adjuster may be pivotably connectable to a seat of a seat assembly. The armrest adjuster may adjust the armrest relative to the armrest mount to (i) an extended position when said seat is adjusted to a first seat position and (ii) a retracted position when said seat is adjusted to a second seat position.

### CROSS-REFERENCE TO RELATED APPLICATION

This application claims priority to Chinese Patent Application No. 202311212505X, filed on Sep. 19, 2023, the content of which is hereby incorporated by reference in its entirety.

### TECHNICAL FIELD

The present disclosure generally relates to seat assemblies, such as for vehicles, having one or more adjustable armrest assemblies.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIGS. 1A-1C are perspective views generally illustrating an embodiment of a seat assembly including a seat disposed in a first seat position, an intermediate seat position, and a second seat position, respectively, according to teachings of the present disclosure.

FIGS. 2A-2C are side views generally illustrating an embodiment of a seat assembly including a seat disposed in a first seat position, an intermediate seat position, and a second seat position, respectively, according to teachings of the present disclosure.

FIG. 3 is a perspective view generally illustrating an embodiment of an armrest frame and an armrest mount of a seat assembly including a seat disposed in a first seat position according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

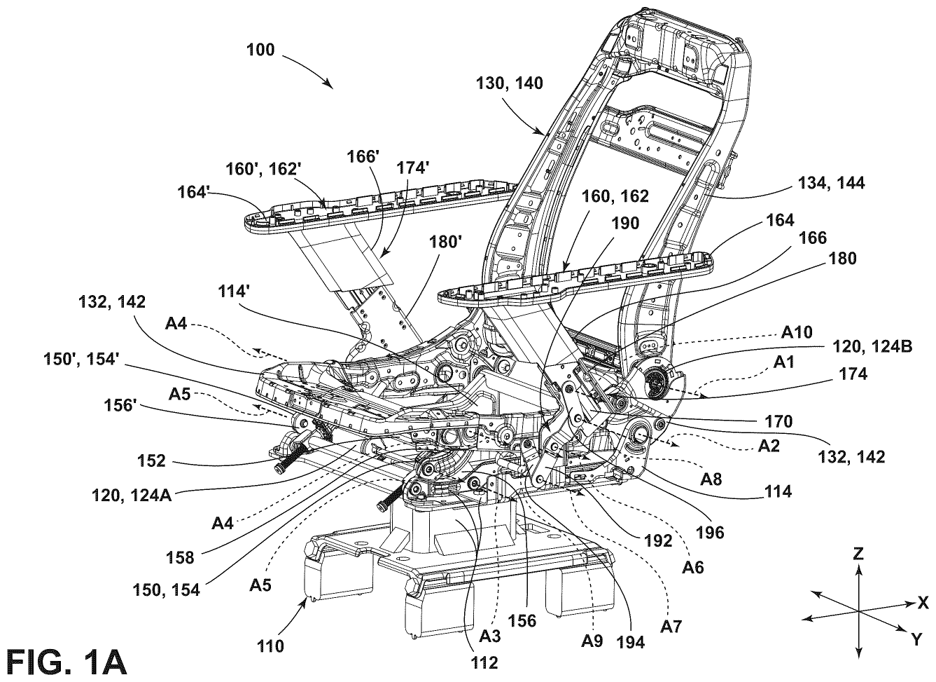

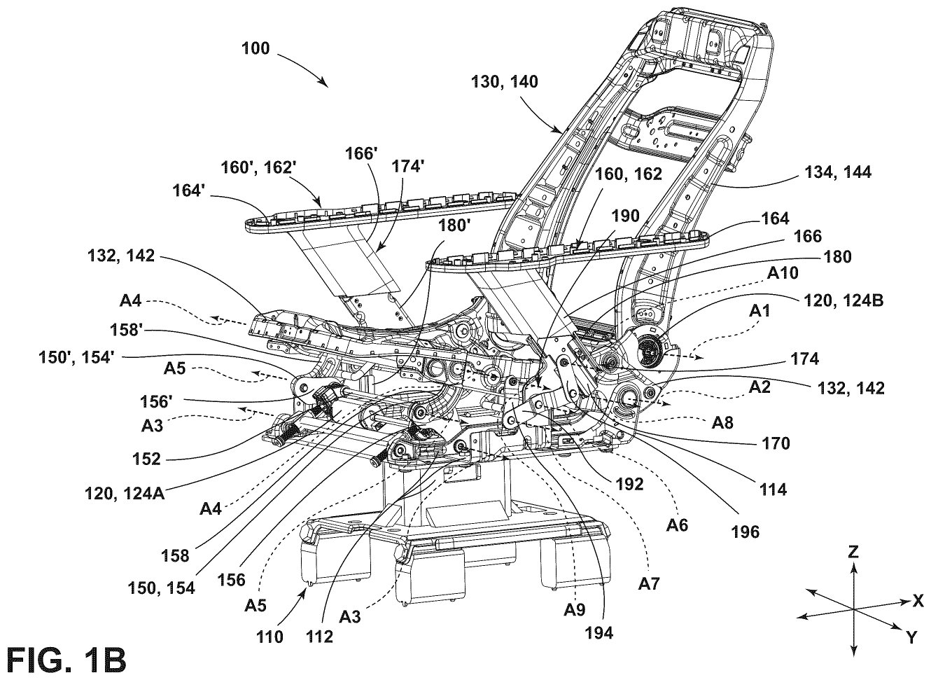

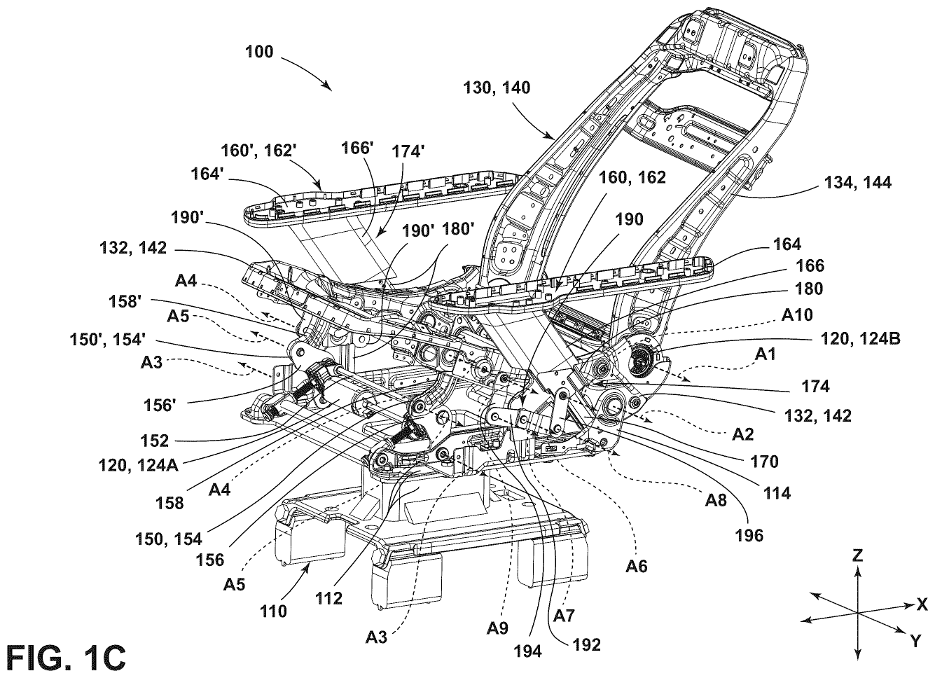

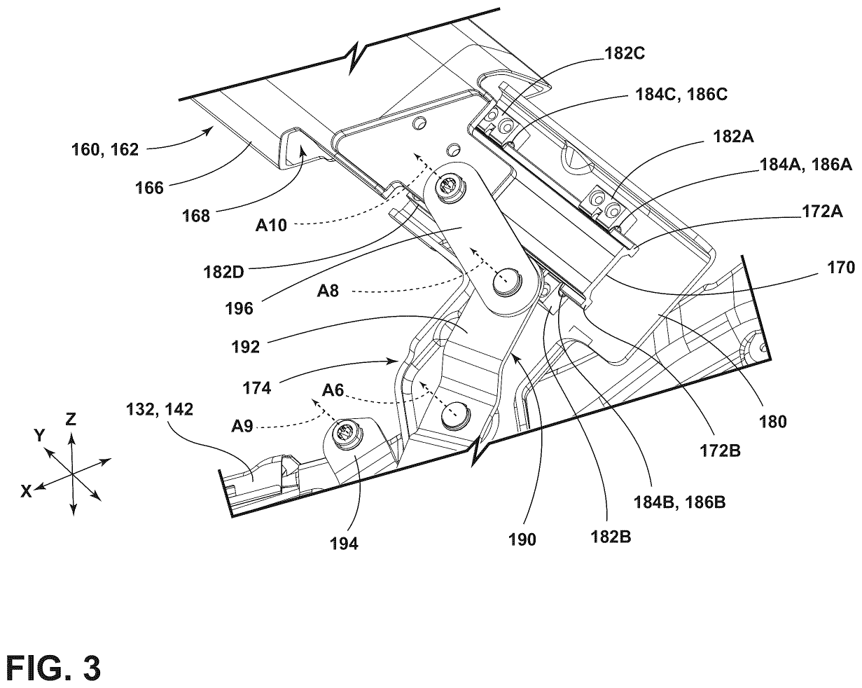

Referring to FIGS. 1A-3, a seat assembly 100 is a modular seat assembly 100 that includes a plurality of components which, when assembled, form a vehicle seat, such as for a passenger vehicle (e.g., cars, vans, SUVs, trucks, buses, trains, boats, ships, planes). The seat assembly 100 may be utilized in any other appropriate situation or apparatus, such as homes, office buildings, theaters, stadiums, recreational vehicles, commercial vehicles, and/or agricultural equipment, among others.

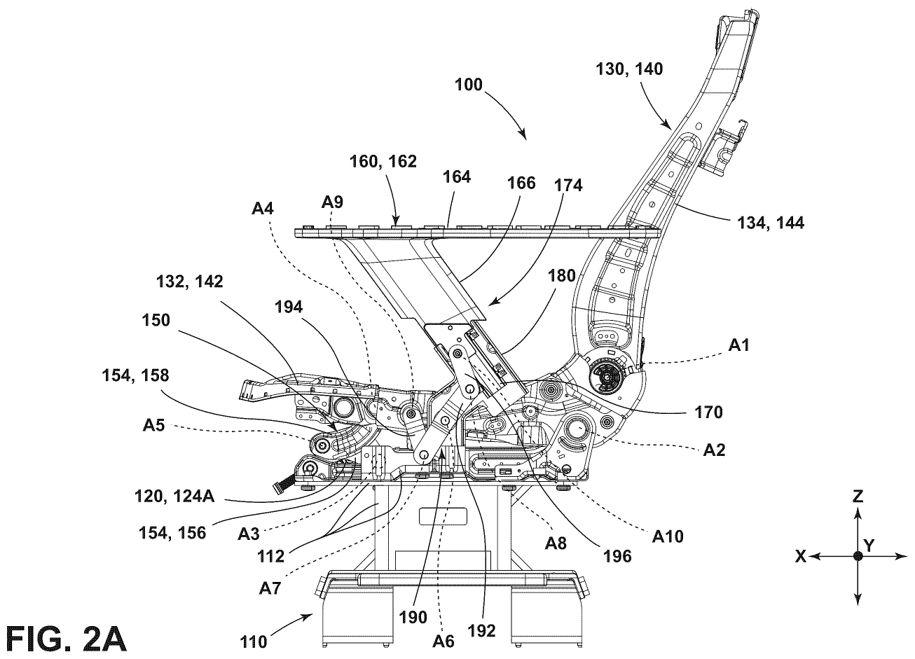

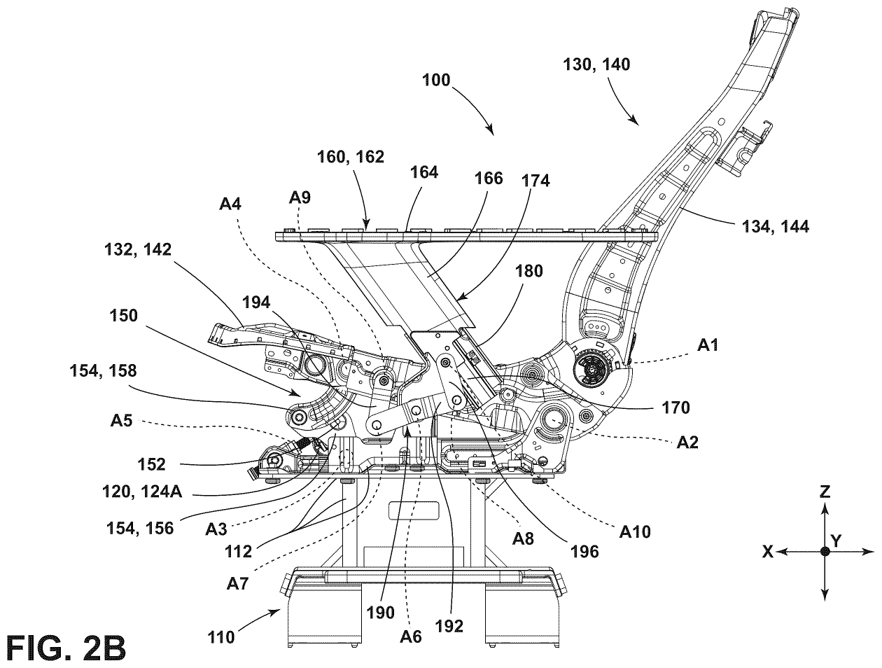

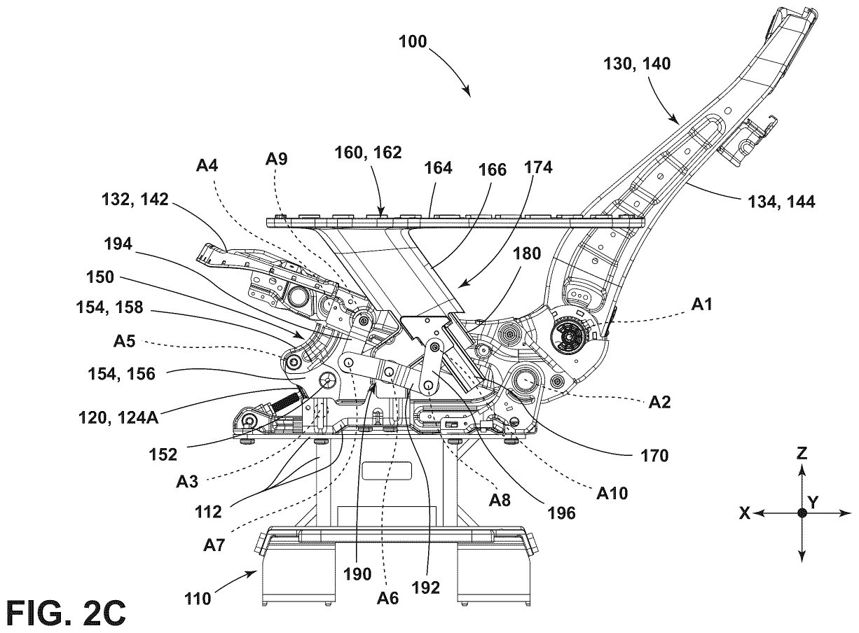

The seat assembly 100 includes a seat base 110, a seat adjuster 120, a seat 130, and one or more adjustable armrest assemblies (e.g., a first armrest assembly 174 and a second armrest assembly 174′). The seat 130 includes a seat bottom 132, a seatback 134, a seat frame 140, and one or more armrests (e.g., a first armrest 160 and a second armrest 160′). Optionally, the seat assembly 100 may also include a track assembly. The seat 130 and/or one or more portions thereof (e.g., the seat bottom 132, the seatback 134, the armrests 160, 160′) include one or more other elements, components, and/or assemblies, such as a pad or cushion, a trim assembly, a support/suspension mat, air bladders, and/or air distributors (e.g., an air conducting layer, a duct, a fan). Portions of the seat 130 are configured to move relative to one another (e.g., adjust, recline, rotate, fold, collapse) and/or along a track assembly (e.g., of a vehicle and/or of the seat assembly 100) via the seat adjuster 120. The seat adjuster 120 is configured to adjust the seat 130 to one or more seat positions, including a first seat position (e.g., a design position and/or a generally upright position) and a second seat position (e.g., a zero-gravity position). FIGS. 1A, 2A, and 3 depict the seat assembly 100 and/or a portion thereof when the seat 130 is in a first seat position. FIGS. 1B and 2B depict the seat assembly 100 when the seat 130 is in an intermediate seat position between a first seat position and a second seat position. FIGS. 1C and 2C depict the seat assembly 100 when the seat 130 is in a second seat position.

Referring to FIGS. 1A and 2A, a first seat position is a so-called ‘design position’. The design position corresponds to an occupant/user of average size seated in a predefined occupant position (e.g., at a predefined location with a predefined orientation and posture). The predefined occupant position is generally established when designing the seat assembly 100 and/or the vehicle (e.g., an interior of the vehicle, including the safety systems such as airbags and seatbelts, may be designed based on an average adult male or female occupant seated in the predefined occupant position). Optionally, the seat 130 is configured to be in the design position when evaluating whether the seat assembly 100 and/or vehicle complies with one or more regulations and/or standards (e.g., safety standards).

Referring to FIGS. 1C and 2C, a second seat position is a so-called ‘zero-gravity position’. When the seat 130 is in the zero-gravity position, an average-sized occupant/user of the seat assembly 100 is positioned such that the occupant's head and knees are raised slightly above at least a portion of the occupant's heart, and the occupant's torso line and thigh line roughly form a 1200 angle (e.g., at the occupant's hips). The zero-gravity position is configured to position the occupant/user is in or near a what is considered a natural body position. The zero-gravity position is also configured to reduce and/or minimize stress on the occupant's spine and pelvis, improve blood flow/circulation, and/or reduce occupant fatigue, which may improve occupant comfort.

Referring to FIGS. 1A-2C, the seat base 110 is connected to the seat 130 and/or the seat adjuster 120. The seat base 110 is connectable and/or connected to one or more objects (e.g., one or more components of vehicle, such as a vehicle floor, and/or the track assembly) to, for example, connect, attach, and/or mount the seat assembly 100 to the object. The seat base 110 includes a main base body 112 and a plurality of rear base bodies (e.g., a first rear base body 114 and a second rear base body 114′). The main base body 112 and/or one or more portions thereof is connected to the object (e.g., a vehicle floor). The rear base bodies 114, 114′ are connected to opposite sides of the main base body 112 at or about a rear end of the main base body 112, which is disposed at or about (e.g., adjacent to) the seatback 134 and/or the seatback frame 144. While the main base body 112 has a pedestal-like shape and/or configuration in FIGS. 1A-2C, the main base body 112 may have a variety of other shapes and/or configurations.

In embodiments, the seat assembly 100 includes a track assembly and the seat base 110 is connected to one or more movable track portions of the track assembly to releasably and/or adjustably connect the seat 130 to the track assembly. The seat 130 may be adjustable (e.g., slidable) along the track assembly via actuation of a motor of the seat adjuster 120, which adjusts (e.g., slides) the movable track portions relative to one or more fixed track portions of the track assembly to adjust the seat base 110, and consequently the seat 130 connected thereto, along the track assembly.

Referring to FIGS. 1A-2C, the seat frame 140 includes a seat bottom frame 142 and a seatback frame 144. The seat frame 140 and/or portions thereof (e.g., the seat bottom frame 142, the seatback frame 144) include one or more members, such as support-members, cross-members, and/or side-members. A member (e.g., a support-member, a cross-member, and/or a side-member) may include one or more of a variety of configurations, such as a member, a beam, a bar, a rod, a plate, and/or a tube.

Referring to FIGS. 1A-2C, the seatback frame 144 is disposed in and/or connected to the seatback 134. The seatback 134 and/or the seatback frame 144 is pivotably connected to the seat bottom 132 and/or the seat bottom frame 142 at or about a first pivot axis A1 (e.g., a seatback pivot axis). The seatback 134 and the seatback frame 144 are pivotable about/around the first pivot axis A1 to adjust an angle/inclination of the seatback 134 and/or the seatback frame 144 relative to the seat base 110, the seat bottom 132, and/or the seat bottom frame 142. The seatback 134 and/or the seatback frame 144 is adjustable about/around the first pivot axis A1 to a first seatback position (see, e.g., FIGS. 1A and 2A) and a second seatback position (see, e.g., FIGS. 1C and 2C). An angle defined between (i) the seatback 134 and the seat bottom 132 and/or (ii) the seatback frame 144 and the seat bottom frame 142 is greater when the seatback 134 and/or the seatback frame 144 is disposed in the second seatback position than when disposed in the first seatback position. The seatback 134 and/or the seatback frame 144 is disposed in the first seatback position when the seat 130 is in a first seat position (e.g., the design position) and is disposed in the second seatback position when the seat 130 is in a second seat position (e.g., the zero-gravity position). Adjusting the seatback 134 to the second seatback position, such as from the first seatback position, adjusts the user's head downward toward the seat base 110 and/or the track assembly (e.g., to a position slightly above a level of the heart of the user).

Referring to FIGS. 1A-2C, the seat bottom frame 142 is disposed in and/or connected to the seat bottom 132. The seat bottom 132 and/or the seat bottom frame 142 is pivotably connected to the seatback 134 and/or the seatback frame 144 at or about the first pivot axis A1. The seat bottom 132 and/or the seat bottom frame 142 is pivotably connected to the rear base bodies 114, 114′ of the seat base 110 at or about a second pivot axis A2 (e.g., a seat bottom pivot axis). The seat bottom 132 and/or the seat bottom frame 142 are also adjustably connected to the seat base 110 (e.g., the main base body 112) via an adjustment member 150. The first pivot axis A1 and the second pivot axis A2 generally extend in the Y-direction. The seat bottom 132 and/or the seat bottom frame 142 is adjustable about/around the second pivot axis A2 to a lowered/default position (see, e.g., FIGS. 1A and 2A) and a raised/elevated position (see, e.g., FIGS. 1C and 2C) to adjust an angle/inclination of the seat bottom 132 and/or the seat bottom frame 142 relative to the seat base 110, the seatback 134, and/or the seatback frame 144. An angle defined between the seat bottom 132 and/or the seat bottom frame 142 and the seat base 110 is greater when the seat bottom 132 and/or the seat bottom frame 142 is disposed in the raised position than when disposed in the lowered position. The seat bottom 132 and/or the seat bottom frame 142 is disposed in the lowered position when the seat 130 is in a first seat position (e.g., the design position) and is disposed in the raised position when the seat 130 is in a second seat position (e.g., the zero-gravity position). Adjusting the seat bottom 132 and/or the seat bottom frame 142 to the raised position, such as from the lowered position, adjusts the user's knees upward away from the track assembly (e.g., to a position closer to, at, and/or slightly above the level of at least a portion the heart of the user).

Referring to FIGS. 1A-2C, the seat assembly 100 and/or the seat base 110 includes an adjustment member 150 that adjustably connects the seat bottom 132 and/or the seat bottom frame 142 to the seat base 110. The adjustment member 150 adjusts the seat bottom 132, the seat bottom frame 142, the first pivot axis A1, the seatback 134, and/or the seatback frame 144 about/around the second pivot axis A2 relative to the seat base 110. The adjustment member 150 is pivotably connected to the main base body 112 of the seat base 110 at or about a third pivot axis A3 (e.g., a member-base pivot axis). The adjustment member 150 is pivotably connected to the seat bottom 132 and/or the seat bottom frame 142 at or about a fourth pivot axis A4 (e.g., a member-seat pivot axis).

Referring to FIGS. 1A-2C, the adjustment member 150 includes a cross-member 152 and a plurality of side-members (e.g., a first side-member 154 and a second side-member 154′). Each of the side-members 154, 154′ include a plurality of links (e.g., a first link 156, 156′ and a second link 158, 158′). The cross-member 152, the side-members 154, 154′, and/or the links 156, 156′, 158, 158′ of the adjustment member 150 may include one or more of a variety of configurations, such as a member, a beam, a bar, a rod, a tube, and/or a plate. An end of the first link 156, 156′ and an end of the second link 158, 158′ are pivotably connected to one another at or about a fifth pivot axis A5 (e.g., a member pivot axis). Another end of the first link 156, 156′ opposite the second link 158, 158′ is pivotably connected to the seat base 110 at or about the third pivot axis A3. Another end of the second link 158, 158′ opposite the first link 156, 156′ is pivotably connected to the seat bottom 132 and/or the seat bottom frame 142 at or about the fourth pivot axis A4. The cross-member 152 extends between and connects the side-members 154, 154′ (e.g., the first links 156, 156′) to one another. The cross-member 152 and the pivot axes A3-A5 extend generally in the Y-direction (e.g., parallel to the pivot axes A1, A2 and/or generally perpendicular to the X-direction). The cross-member 152 is connected (e.g., physically and/or operably) to a first motor 124A of the seat adjuster 120, which when actuated moves and/or adjusts the adjustment member 150.

Referring to FIGS. 1A-2C, the adjustment member 150 and/or one or more portions thereof are pivotable about/around one or more of the pivot axes A3-A5 via actuation of the first motor 124A of the seat adjuster 120 to move and/or adjust the adjustment member 150, the seat bottom 132, the seat bottom frame 142, the first pivot axis A1, the seatback 134, and/or the seatback frame 144 relative to the seat base 110 (e.g., the main base body 112). The adjustment member 150 and/or one or more portions thereof are adjustable about/around the pivot axes A3-A5 to a first member position (see, e.g., FIGS. 1A and 2A) and a second member position (see, e.g., FIGS. 1C and 2C). When the adjustment member 150 is in the first member position, (i) the seat bottom 132 and/or the seat bottom frame 142 is in the lowered position and (ii) a first angle is defined between the first links 156, 156′ and the second links 158, 158′ and/or between a first imaginary line connecting pivot axes A5, A3 and a second imaginary line connecting pivot axes A5, A4. When the adjustment member 150 is in the second member position, (i) the seat bottom 132 and/or the seat bottom frame 142 is in the raised position and (ii) a second angle, which is greater than the first angle, is defined between the first links 156, 156′ and the second links 158, 158′ and/or between the first imaginary line connecting pivot axes A5, A3 and the second imaginary line connecting pivot axes A5, A4. The adjustment member 150 is disposed in the first member position when the seat 130 is in a first seat position (e.g., the design position) and is disposed in the second member position when the seat 130 is in a second seat position (e.g., the zero-gravity position).

Referring to FIGS. 1A-3, the seat assembly 100 and/or the seat 130 includes one or more armrests (e.g., a first armrest 160 and a second armrest 160′) on which an occupant of the seat assembly 100 may rest their arm(s). The first armrest 160 and the second armrest 160′ are disposed on and connected to opposite sides of the seat base 110 relative to the Y-direction via a first armrest mount 180 and a second armrest mount 180′, respectively. The seat frame 140, the seat bottom 132, and/or the seatback 134 are disposed between the armrests 160, 160′ relative to the Y-direction. The armrests 160, 160′ each include an armrest frame (e.g., a first armrest frame 162 and a second armrest frame 162′). The armrests 160, 160′ and/or the armrest frames 162, 162′ are adjustable, moveable, slidable, and/or translatable to an extended position (see, e.g., FIGS. 1A and 2A) and a retracted position (see, e.g., FIGS. 1C and 2C) to adjust (i) a height of the armrests 160, 160′, (ii) a height of the armrest frames 162, 162′, (iii) a distance (e.g., generally in the Z-direction) between the armrests 160, 160′ and the main base body 112 of the seat base 110, the seat bottom 132, and/or the seat bottom frame 142, and/or (iv) a distance (e.g., generally in the Z-direction) between the armrest frames 162, 162′ (e.g., the arm support bodies 164, 164′) and the armrest mounts 180, 180′, the main base body 112 of the seat base 110, the seat bottom 132, and/or the seat bottom frame 142. The armrests 160, 160′ and/or the armrest frames 162, 162′ (e.g., the arm support bodies 164, 164′) are disposed farther from the seat base 110 and/or the armrest mounts 180, 180′ when disposed in the extended position than when in the retracted position. The armrests 160, 160′ and/or armrest frames 162, 162′ are disposed in the extended position when the seat 130 is in a first seat position (e.g., the design position) and are disposed in the retracted position when the seat 130 is in a second seat position (e.g., the zero-gravity position).

The first armrest 160 and/or the first armrest frame 162 is adjustably (e.g., slidably) connected to the first armrest mount 180. The first armrest frame 162 includes an arm support body 164, a protrusion 166, and a slider 170.

The arm support body 164 extends generally in the X-direction (e.g., obliquely or perpendicularly to a direction of gravity) and is configured to contact and support an arm of an occupant of the seat assembly 100. One or more components and/or elements (e.g., a pad, cushion, trim assembly, cupholder) of the first armrest 160 may be disposed on and/or connected to the arm support body 164. An orientation of the arm support body 164 relative to the seat base 110 is maintained generally constant as the first armrest 160 is adjusted from the extended position to the retracted position and is adjusted from the retracted position to the extended position.

The protrusion 166 extends and/or protrudes from the arm support body 164 generally toward the first rear base body 114 of the seat base 110 (e.g., generally perpendicularly to the Y-direction and transversely to the X-direction and to the Z-direction). The protrusion 166 is a hollow, rectangular, tubular body defining an interior space 168 for selectively receiving at least a portion of the first armrest mount 180. The slider 170 is connected to and/or integrally formed with the protrusion 166. The slider 170 is disposed partially within the interior space 168 of the protrusion 166. The slider 170 projects out from the interior space 168 and protrudes from a free end of the protrusion 166. The slider 170 includes one or more projections or rails (e.g., a first projection 172A and a second projection 172B) that slidably engage the first armrest mount 180 (e.g., the connectors 182A-182D, guide surfaces 184A-184C, and/or grooves 186A-186C), which slidably connects the first armrest 160 and the first armrest mount 180. The first projection 172A and the second projection 172B extend from opposite sides of the slider 170 and extend along a longitudinal extent of the slider 170.

The second armrest frame 162′ includes an arm support body 164′, a protrusion 166′, an interior space, a slider, and one or more projections that are configured in a substantially similar manner to the corresponding elements of the first armrest frame 162 described above.

Referring to FIGS. 1A-3, the seat assembly 100 and/or the seat base 110 include one or more armrest mounts (e.g., a first armrest mount 180 and a second armrest mount 180′) and one or more armrest adjusters (e.g., a first armrest adjuster 190 and a second armrest adjuster 190′). The first armrest mount 180 and the second armrest mount 180′ adjustably connect the first armrest 160 and the second armrest 160′ to the seat base 110, respectively. The first armrest mount 180 and the second armrest mount 180′ are disposed on and connected to opposite sides of the main base body 112 relative to the Y-direction. The armrest adjusters 190, 190′ connect the armrests 160, 160′ to the seat bottom frame 142 such that adjusting the seat bottom 132 and/or the seat bottom frame 142 simultaneously adjusts a position of the armrests 160, 160′ and/or the armrest frames 162, 162′. The first armrest adjuster 190 extends between and connects the first armrest 160, the first armrest frame 162, the first armrest mount 180 (e.g., the seat base 110), the seat bottom 132, and/or the seat bottom frame 142 to one another. The second armrest adjuster 190′ extends between and connects the second armrest 160′, the second armrest frame 162′, the second armrest mount 180′ (e.g., the seat base 110), the seat bottom 132, and/or the seat bottom frame 142 to one another. The second armrest 160′, the second armrest frame 162′, the second armrest mount 180′, and the second armrest adjuster 190′ are configured in a substantially similar manner to (e.g., are mirrored configurations of) the first armrest 160, the first armrest frame 162, the first armrest mount 180, and the first armrest adjuster 190, respectively. The first armrest 160 (e.g., the first armrest frame 162), the first armrest mount 180, and the first armrest adjuster 190 define the first adjustable armrest assembly 174 of the seat assembly 100. The second armrest 160′ (e.g., the second armrest frame 162′), the second armrest mount 180′, and the second armrest adjuster 190′ define the second adjustable armrest assembly 174′ of the seat assembly 100.

The first armrest mount 180 adjustably connects the first armrest 160 and/or the first armrest frame 162 to the seat base 110. The first armrest mount 180 is connected and/or attached (e.g., fixed) to the main base body 112 of the seat base 110. The first armrest mount 180 extends and/or projects obliquely or perpendicularly from the main base body 112 (e.g., generally vertically, in the Z-direction, and/or toward the arm support body 164 of the first armrest frame 162). The first armrest mount 180 is disposed at least partially in the interior space 168 of the armrest frame 162 at least when the first armrest 160 is disposed in the retracted position.

The first armrest mount 180 includes one or more connectors 182A-182D (e.g., a first, second, third, and fourth connectors 182A-182D). The connectors 182A-182D engage the armrest frame 162 (e.g., the projections 172A, 172B of the slider 170) and adjustably (e.g., slidably) connect the first armrest 160 and/or the first armrest frame 162 to the first armrest mount 180. The connectors 182A-182D each include, have, and/or define one or more of guide surfaces, in which the guide surfaces 184A-184C form and/or define a groove 186A-186C of some of the connector 182A-182D. The groove 186A-186C receives at least a portion of the first armrest frame 162 (e.g., a projection 172A, 172B of the slider 170), which adjustably and/or slidably secures, attaches, and/or connects the first armrest frame 162 to the first armrest mount 180. The guide surfaces 184A-184C (e.g., slidably) engage, contact, and/or support the first armrest frame 162 (e.g., the projections 172A, 172B and/or the slider 170) and facilitate, direct, and/or guide adjustment and/or movement of the first armrest 160 and/or the first armrest frame 162 relative to the first armrest mount 180, the seat base 110, the seat bottom frame 142, and/or the seat bottom 132 (e.g., generally obliquely or perpendicularly to the Y-direction).

The first connector 182A and the second connector 182B define a first connector pair. The first and second connectors 182A, 182B are disposed opposite and/or spaced apart from one another and are oriented such that their grooves 186A, 186B open toward each other. The third connector 182C and the fourth connector 182D define a second connector pair. The third and fourth connectors 182C, 182D are disposed opposite and/or spaced apart from one another and are oriented such that their grooves open toward each other. The first connector pair 182A, 182B and the second connector pair 182C, 182D are disposed spaced apart from one another in a longitudinal direction of the slider 170. The first projection 172A of the slider 170 slidably engages the groove 186A and guide surface 184A of the first connector 182A and the groove 186C and guide surface 184C of the third connector 182C. The second projection 172B of the slider 170 slidably engages the groove 186B and guide surface 184B of the second connector 182B and the groove and guide surface of the fourth connector 182D. The connectors 182A-182D may alternately have other suitable configurations, elements, and/or structures. Additionally and/or alternatively, the first armrest mount 180 and/or one or more other portions thereof may include and/or define one or more of the guide surfaces 184A-184C.

The second armrest mount 180′ includes a plurality of connectors, grooves, and guide surfaces that are configured in a substantially similar manner to the corresponding elements of the first armrest mount 180 described above.

Referring to FIGS. 1A-2C, the first armrest adjuster 190 is adjustably (e.g., pivotably) connected to the first armrest 160 (e.g., the first armrest frame 162), the first armrest mount 180, and the seat 130 (e.g., the seat bottom 132 and/or the seat bottom frame 142). The first armrest adjuster 190 simultaneously adjusts the armrest 160, relative to the first armrest mount 180 and the seat base 110, to and/or toward (i) the extended position when the seat adjuster 120 adjusts the seat 130 to and/or toward a first seat position and (ii) the retracted position when the seat adjuster 120 adjusts the seat 130 to and/or toward a second seat position. The first armrest adjuster 190 includes a plurality of links 192, 194, 196 that are pivotably connected to one another, the seat 130 (e.g., the seat bottom 132 and/or the seat bottom frame 142), the first armrest 160, and the first armrest mount 180. The plurality of links include a pivot link 192, a drive link 194, and a follow link 196. The pivot link 192 is pivotably connected to and/or mounted on the first armrest mount 180 at or about a sixth pivot axis A6 (e.g., a link-mount pivot axis). A first longitudinal end of the pivot link 192 is pivotably connected to the drive link 194 at or about a seventh pivot axis A7 (e.g., a pivot-drive pivot axis). A second, opposite longitudinal end of the pivot link 192 is pivotably connected to the follow link 196 at or about an eighth pivot axis A8 (e.g., a pivot-follow pivot axis). A first longitudinal end of the drive link 194 is pivotably connected to the seat bottom frame 142 at or about a ninth pivot axis A9 (e.g., a link-seat pivot axis). A second, opposite longitudinal end of the drive link 194 is pivotably connected to the first end of the pivot link 192 at or about the seventh pivot axis A7. A first longitudinal end of the follow link 196 is pivotably connected to the protrusion 166 of the armrest frame 162 at or about a tenth pivot axis A10 (e.g., a link-armrest 160 pivot axis). A second, opposite longitudinal end of the follow link 196 is pivotably connected to the second end of the pivot link 192 at or about the eighth pivot axis A8. The links 192-196 may include one or more of a variety of configurations, such as a member, a beam, a bar, a rod, a tube, and/or a plate.

The second armrest adjuster 190′ includes a pivot link, a drive link, and a follow link that are configured in a substantially similar manner to the corresponding elements of the first armrest adjuster 190 described above.

Referring to FIGS. 1A-2C, the armrest adjusters 190, 190′ and/or one or more portions thereof are pivotable about/around one or more of the pivot axes A6-A10 via adjusting and/or moving the seat bottom 132 and/or the seat bottom frame 142 relative to the seat base 110 (e.g., pivoting the seat bottom frame 142 about the second pivot axis A2 via adjusting the adjustment member 150). The armrest adjusters 190, 190′ and/or one or more portions thereof are adjustable, rotatable, and/or pivotable about/around one or more of the pivot axes A6-A10 to a first adjuster position (see, e.g., FIGS. 1A, 2A, 3) and a second adjuster position (see, e.g., FIGS. 1B and 2B). When the armrest adjusters 190, 190′ are in the first adjuster position, the ninth pivot axis A9 and the tenth pivot axis A10 are a disposed a first distance (e.g., a vertical distance and/or generally in the Z-direction) from one another, the seventh pivot axis A7 is disposed below the sixth pivot axis A6 relative to the Z-direction, and the eighth pivot axis A8 is disposed above the sixth pivot axis A6 relative to the Z-direction. When the armrest adjusters 190, 190′ are in the second adjuster position, the ninth pivot axis A9 and the tenth pivot axis A10 are a disposed a second distance (e.g., a vertical distance and/or generally in the Z-direction) from one another, which is smaller than the first distance, the seventh pivot axis A7 is disposed above the sixth pivot axis A6 relative to the Z-direction, and the eighth pivot axis A8 is disposed below the sixth pivot axis A6 relative to the Z-direction.

The armrest adjusters 190, 190′ are disposed in the first adjuster position when (i) the armrests 160, 160′ and/or armrest frames 162, 162′ are disposed in the extended position, (ii) the seat bottom 132 and/or the seat bottom frame 142 is disposed in the lowered position, and/or (iii) the seat 130 is disposed in a first seat position (e.g., the design position). The armrest adjusters 190, 190′ are disposed in the second adjuster position when (i) the armrests 160, 160′ and/or armrest frames 162, 162′ are disposed in the retracted position, (ii) the seat bottom 132 and/or the seat bottom frame 142 is disposed in the raised position, and/or (iii) the seat 130 is disposed in a second seat position (e.g., the zero-gravity position).

Referring to FIGS. 1A-2C, the seat adjuster 120 is connected (e.g., physically and/or operably) to the seat 130, the seat base 110, and/or the adjustment member 150. The seat adjuster 120 includes a controller and one or more motors (e.g., a first motor 124A, a second motor 124B). The seat adjuster 120 and/or the controller actuate and/or otherwise control the one or more motors 124A, 124B (e.g., individually and/or simultaneously). In examples, the seat adjuster 120 and/or the controller includes an electronic controller and/or includes an electronic processor, such as a programmable microprocessor and/or microcontroller. The seat adjuster 120 and/or the controller may also include, for example, an application specific integrated circuit (ASIC), a central processing unit (CPU), a memory (e.g., a non-transitory computer-readable storage medium), and/or an input/output (I/O) interface. The seat adjuster 120 and/or the controller is configured to perform various functions, including those described in greater detail herein, with appropriate programming instructions and/or code embodied in software, hardware, and/or other medium. The seat adjuster 120 and/or the controller may be connected to a display, such as a touchscreen display.

The seat adjuster 120 includes a first motor 124A that is physically and/or operatively connected to the adjustment member 150 (e.g., the cross-member 152) and the seat base 110 (e.g., the main base body 112). The first motor 124A adjusts a position of the adjustment member 150 relative to the seat base 110 (e.g., the main base body 112), the seat bottom 132, and/or the seat bottom frame 142 when actuated by the seat adjuster 120 to, in turn, adjust a position of the seat bottom 132 and/or the seat bottom frame 142 (e.g., to the lowered position and/or to the raised position), the first pivot axis A1, the seatback 134 and/or the seatback frame 144, the armrests 160, 160′ and/or the armrest frames 162, 162′ (e.g., to the extended position and/or to the retracted position), and the armrest adjusters 190, 190′ (e.g., to the first adjuster position and/or to the second adjuster position) relative to the seat base 110.

Optionally, the seat adjuster 120 includes a second motor 124B that is physically and/or operatively connected to the seatback 134, the seatback frame 144, the seat bottom 132, and/or the seat bottom frame 142. The second motor 124B adjusts a position of the seatback 134 and/or the seatback frame 144 relative to the seat bottom 132 and/or the seat bottom frame 142 when actuated by the seat adjuster 120 to, for example, adjust the seatback 134 and/or the seatback frame 144 to the first seatback position and/or to the second seatback position.

Referring to FIGS. 1A and 2A, portions of the seat assembly 100 are disposed as described below when the seat 130 is in a first seat position (e.g., the design position). The seat bottom 132 and/or the seat bottom frame 142 are disposed in the lowered position. The seatback 134 and/or the seatback frame 144 are disposed in the first seatback position. The armrests 160, 160′ and/or the armrest frames 162, 162′ are disposed in the extended position. The adjustment member 150 is disposed in the first member position. The armrest adjusters 190, 190′ are disposed in the first adjuster position.

Referring to FIGS. 1C and 2C, portions of the seat assembly 100 are disposed as described below when the seat 130 is in a second seat position (e.g., the zero-gravity position). The seat bottom 132 and/or the seat bottom frame 142 are disposed in the raised position. The seatback 134 and/or the seatback frame 144 are disposed in the second seatback position. The armrests 160, 160′ and/or the armrest frames 162, 162′ are disposed in the retracted position. The adjustment member 150 is disposed in the second member position. The armrest adjusters 190, 190′ are disposed in the second adjuster position.

The seat adjuster 120 adjusts the seat 130 to one or more seat positions, including a first seat position (e.g., a design position) and a second seat position (e.g., a zero-gravity position). When adjusting the seat 130 from a first seat position to a second seat position or vice versa, the seat adjuster 120 actuates the first motor 124A and, optionally, actuates (e.g., simultaneously) the second motor 124B.

For example, when adjusting the seat 130 from a first seat position to a second seat position, the seat adjuster 120 actuates the first motor 124A to adjust the adjustment member 150 from the first member position to the second member position, which adjusts the seat bottom 132 and/or the seat bottom frame 142 from the lowered position to the raised position, which adjusts the armrest adjusters 190, 190′ from the first adjuster position to the second adjuster position, which adjusts the armrests 160, 160′ and/or the armrest frames 162, 162′ from the extended position to the retracted position. Optionally, the seat adjuster 120 also (e.g., simultaneously) actuates the second motor 124B to adjust the seatback 134 from the first seatback position to the second seatback position.

As generally illustrated in FIGS. 1A-1C and 2A-2C, when adjusting the seat 130 from a first seat position to a second seat position, actuating the first motor 124A causes the first motor 124A to adjust, move, and/or push the cross-member 152 of the adjustment member 150 away from the seat base 110 and/or toward the armrests 160, 160′ and/or the armrest frames 162, 162′. This movement rotates the first links 156, 156′ about the third pivot axis A3 relative to the seat base 110, which adjusts, moves, and/or shifts the fifth pivot axis A5 away from the seat base 110 (e.g., generally in the Z-direction). This in turn rotates the first links 156, 156′ and the second links 158, 158′ relative to one another about the fifth pivot axis A5 increasing the angle defined therebetween (e.g., from the first angle to the second angle) such that the adjustment member 150 is adjusted from the first member position to the second member position. This also causes the second links 158, 158′ to adjust, move, and/or push the fourth pivot axis A4, a portion of the seat bottom 132, and/or a portion of the seat bottom frame 142 away from the seat base 110 (e.g., generally in the Z-direction). As a result, the seat bottom 132, the seat bottom frame 142, the first pivot axis A1, the seatback 134, and the seatback frame 144 are adjusted, pivoted, and/or rotated about the second pivot axis A2 relative to the seat base 110 such that the seat bottom 132 and/or the seat bottom frame 142 is adjusted from the lowered position to the raised position.

As generally illustrated in FIGS. 2A-2C, the adjustment of the seat bottom 132 and/or the seat bottom frame 142 about the second pivot axis A2 to the raised position adjusts and/or moves the ninth pivot axis A9 and the drive link 194 of the first armrest adjuster 190 away from the seat base 110 (e.g., generally in the Z-direction). This causes the drive link 194 to adjust, move, and/or pull the seventh pivot axis A7 and the first end of the pivot link 192 away from the seat base 110, causing the pivot link 192 to rotate about the sixth pivot axis A6 relative to the first armrest mount 180. This rotation of the pivot link 192 adjusts, moves, and/or rotates the second end of the pivot link 192, the eighth pivot axis A8, and the follow link 196 toward the seat base 110, which decreases the distance between the ninth pivot axis A9 and the tenth pivot axis A10 (e.g., from the first distance to the second distance) and adjusts the armrest adjuster 190 from the first adjuster position to the second adjuster position. This adjustment of the follow link 196 adjusts, moves, and/or pulls the tenth pivot axis A10, the first armrest 160, and/or the first armrest frame 162 toward the seat base 110, which reduces the distance between the seat base 110 and the first armrest 160, the first armrest frame 162, and/or the arm support body 164 and adjusts the first armrest 160 from the extended position to the retracted position. When the first armrest 160 and/or the first armrest frame 162 is adjusting and/or moving toward the seat base 110, the projections 172A, 172B of the slider 170 adjust, move, and/or slide through the grooves 186A-186C and/or along the guide surfaces 184A-184C of the connectors 182A-182D of the first armrest mount 180, which guides the adjustment and/or movement of the first armrest 160 and/or the first armrest frame 162 relative to the first armrest mount 180. While this adjustment process is described with respect to the first armrest adjuster 190 and the first armrest 160, a substantially similar (e.g., identical) process simultaneously occurs with respect to the second armrest adjuster 190′ and the second armrest 160′.

When adjusting the seat 130 from a second seat position to a first seat position, the seat adjuster 120 actuates the first motor 124A to adjust the adjustment member 150 from the second member position to the first member position, which adjusts the seat bottom 132 and/or the seat bottom frame 142 from the raised position to the lowered position, which adjusts the armrest adjusters 190, 190′ from the second adjuster position to the first adjuster position, which adjusts the armrests 160, 160′ and/or the armrest frames 162, 162′ from the retracted position to the extended position. Optionally, the seat adjuster 120 also (e.g., simultaneously) actuates the second motor 124B to adjust the seatback 134 from the second seatback position to the first seatback position. When adjusting the seat 130 from a second seat position to a first seat position, actuating the first motor 124A causes the detailed adjustment process described in the two paragraphs immediately preceding this paragraph to occur in reverse.

In other embodiments, the seat assembly 100 and/or the seat adjuster 120 does not include a second motor 124B. The seatback 134 and/or the seatback frame 144, in such embodiments, may be adjustable about the first pivot axis A1 manually and/or via the first motor 124A. Adjusting the adjustment member 150 about the third pivot axis A3 (e.g., toward the first member position and/or toward the second member position) by actuating the first motor 124A may simultaneously rotate (i) the seat bottom 132, the seat bottom frame 142, the first pivot axis A1, the seatback 134, and/or the seatback frame 144 about the second pivot axis A2 relative to the seat base 110 and (ii) the seatback 134 and/or the seatback frame 144 about the first pivot axis A1 relative to the seat bottom 132 and/or the seat bottom frame 142. For example, in some embodiments, actuating the first motor 124A to adjust the adjustment member 150 from the first member position to the second member position simultaneously adjusts (i) the seat bottom 132 and/or the seat bottom frame 142 about the second pivot axis A2 relative to the seat base 110 toward the raised position and (ii) the seatback 134 and/or the seatback frame 144 about the first pivot axis A1 relative to the seat bottom 132 and/or seat bottom frame 142 toward the second seatback position.

The disclosure includes, without limitation, the following embodiments:

1. An adjustable armrest assembly, comprising: an armrest mount; an armrest adjustably connected to the armrest mount; and an armrest adjuster pivotably connected to the armrest and to the armrest mount; wherein the armrest adjuster is pivotably connectable to a seat of a seat assembly; and wherein the armrest adjuster adjusts the armrest relative to the armrest mount to: an extended position when said seat is adjusted to a first seat position; and a retracted position when said seat is adjusted to a second seat position.

2. The adjustable armrest assembly according to embodiment 1, wherein: said first seat position is a design position; and said second seat position is a zero-gravity position.

3. The adjustable armrest assembly according to any of the preceding embodiments, wherein the armrest adjuster includes a plurality of links pivotably connected to one another.

4. The adjustable armrest assembly according to any of the preceding embodiments, wherein the plurality of links includes a pivot link, a drive link, and a follow link.

5. The adjustable armrest assembly according to any of the preceding embodiments, wherein: the pivot link is pivotably connected to the armrest mount at or about a link-mount pivot axis; the pivot link is pivotably connected to the drive link at or about a pivot-drive pivot axis; the pivot link is pivotably connected to the follow link at or about a pivot-follow pivot axis; the drive link is pivotably connectable to said seat at or about a link-seat pivot axis; and the follow link is pivotably connected to the armrest at or about a link-armrest pivot axis.

6. The adjustable armrest assembly according to any of the preceding embodiments, wherein: the armrest adjuster is disposed in a first adjuster position when said seat is disposed in said first seat position; and the armrest adjuster is disposed in a second adjuster position when said seat is disposed in said second seat position.

7. The adjustable armrest assembly according to any of the preceding embodiments, wherein: the link-seat pivot axis and the link-armrest pivot axis are disposed a first distance from one another when the armrest adjuster is disposed in the first adjuster position; the link-seat pivot axis and the link-armrest pivot axis are disposed a second distance from one another when the armrest adjuster is disposed in the second adjuster position; and the second distance is smaller than the first distance.

8. The adjustable armrest assembly according to any of the preceding embodiments, wherein the armrest is slidably connected to the armrest mount.

9. The adjustable armrest assembly according to any of the preceding embodiments, wherein: the armrest mount includes at least one connector; and the armrest includes a slider engaged with the connector and slidably connects the armrest and the armrest mount.

10. The adjustable armrest assembly according to any of the preceding embodiments, wherein: the at least one connector includes a groove and a guide surface defining the groove; and the slider includes a projection disposed in the groove of the at least one connector.

11. The adjustable armrest assembly according to any of the preceding embodiments, wherein: the armrest includes an armrest frame; the armrest frame includes an arm support body; and an orientation of the arm support body is maintained as the armrest is adjusted from the extended position to the retracted position and is adjusted from the retracted position to the extended position.

12. The adjustable armrest assembly according to any of the preceding embodiments, wherein the arm support body is disposed farther from the armrest mount when the armrest is disposed in the extended position than when the armrest is disposed in the retracted position.

13. The adjustable armrest assembly according to any of the preceding embodiments, wherein: the armrest includes an armrest frame; the armrest frame includes a projection defining an interior space; and when the armrest is disposed in the retracted position, the armrest mount is disposed at least partially in the interior space.

14. A seat assembly, comprising: a seat base; a seat connected to the seat base, the seat including: a seatback; a seat bottom; and an armrest; a seat adjuster connected to the seat; and an adjustable armrest assembly including: the armrest; an armrest mount connected to the seat base, the armrest adjustably connected to the armrest mount; and an armrest adjuster pivotably connected to the armrest, the armrest mount, and the seat bottom; wherein the seat adjuster includes one or more motors; wherein the seat adjuster adjusts the seat to a first seat position or to a second seat position via adjusting the seat bottom and the seatback; and wherein the armrest adjuster simultaneously adjusts the armrest relative to the armrest mount to: an extended position when the seat adjuster adjusts the seat to the first seat position; and a retracted position when the seat adjuster adjusts the seat to the second seat position.

15. The seat assembly according to embodiment 14, wherein: the first seat position is a design position; and the second seat position is a zero-gravity position.

16. The seat assembly according to any of the preceding embodiments, wherein: the armrest adjuster includes a pivot link, a drive link, and a follow link; the pivot link is pivotably connected to the armrest mount at or about a link-mount pivot axis; the pivot link is pivotably connected to the drive link at or about a pivot-drive pivot axis; the pivot link is pivotably connected to the follow link at or about a pivot-follow pivot axis; the drive link is pivotably connected to the seat bottom at or about a link-seat pivot axis; and the follow link is pivotably connected to the armrest at or about a link-armrest pivot axis.

17. The seat assembly according to any of the preceding embodiments, wherein the link-mount pivot axis, the link-seat pivot axis, the link-armrest pivot axis, the pivot-drive pivot axis, and the pivot-follow pivot axis extend substantially parallel to one another.

18. The seat assembly according to any of the preceding embodiments, wherein: the armrest includes an armrest frame; the armrest frame includes an arm support body; and an orientation of the arm support body relative to the seat base is maintained as the armrest is adjusted from the extended position to the retracted position and is adjusted from the retracted position to the extended position.

19. The seat assembly according to any of the preceding embodiments, wherein the arm support body is disposed farther from the seat base when the armrest is disposed in the extended position than when the armrest is disposed in the retracted position.

20. The seat assembly according to any of the preceding embodiments, wherein: the armrest includes a slider; and the armrest mount includes a guide surface that slidably engages the slider and guides adjustment of the armrest to the extended position or to the retracted position.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

It should be understood that a computer/computing device, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An adjustable armrest assembly, comprising:
an armrest mount;
an armrest adjustably connected to the armrest mount; and
an armrest adjuster pivotably connected to the armrest and to the armrest mount;
wherein the armrest adjuster is pivotably connectable to a seat of a seat assembly; and
wherein the armrest adjuster adjusts the armrest relative to the armrest mount to:
an extended position when said seat is adjusted to a first seat position; and
a retracted position when said seat is adjusted to a second seat position.

2. The adjustable armrest assembly of claim 1, wherein:
said first seat position is a design position; and
said second seat position is a zero-gravity position.

3. The adjustable armrest assembly of claim 1, wherein the armrest adjuster includes a plurality of links pivotably connected to one another.

4. The adjustable armrest assembly of claim 3, wherein the plurality of links includes a pivot link, a drive link, and a follow link.

5. The adjustable armrest assembly of claim 4, wherein:
the pivot link is pivotably connected to the armrest mount at or about a link-mount pivot axis;
the pivot link is pivotably connected to the drive link at or about a pivot-drive pivot axis;
the pivot link is pivotably connected to the follow link at or about a pivot-follow pivot axis;
the drive link is pivotably connectable to said seat at or about a link-seat pivot axis; and
the follow link is pivotably connected to the armrest at or about a link-armrest pivot axis.

6. The adjustable armrest assembly of claim 5, wherein:
the armrest adjuster is disposed in a first adjuster position when said seat is disposed in said first seat position; and
the armrest adjuster is disposed in a second adjuster position when said seat is disposed in said second seat position.

7. The adjustable armrest assembly of claim 6, wherein:
the link-seat pivot axis and the link-armrest pivot axis are disposed a first distance from one another when the armrest adjuster is disposed in the first adjuster position;
the link-seat pivot axis and the link-armrest pivot axis are disposed a second distance from one another when the armrest adjuster is disposed in the second adjuster position; and
the second distance is smaller than the first distance.

8. The adjustable armrest assembly of claim 1, wherein the armrest is slidably connected to the armrest mount.

9. The adjustable armrest assembly of claim 1, wherein:
the armrest mount includes at least one connector; and
the armrest includes a slider engaged with the connector and slidably connects the armrest and the armrest mount.

10. The adjustable armrest assembly of claim 9, wherein:
the at least one connector includes a groove and a guide surface defining the groove; and
the slider includes a projection disposed in the groove of the at least one connector.

11. The adjustable armrest assembly of claim 1, wherein:
the armrest includes an armrest frame;
the armrest frame includes an arm support body; and
an orientation of the arm support body is maintained as the armrest is adjusted from the extended position to the retracted position and is adjusted from the retracted position to the extended position.

12. The adjustable armrest assembly of claim 11, wherein the arm support body is disposed farther from the armrest mount when the armrest is disposed in the extended position than when the armrest is disposed in the retracted position.

13. The adjustable armrest assembly of claim 1, wherein:
the armrest includes an armrest frame;
the armrest frame includes a projection defining an interior space; and
when the armrest is disposed in the retracted position, the armrest mount is disposed at least partially in the interior space.

14. A seat assembly, comprising:
a seat base;
a seat connected to the seat base, the seat including:
a seatback;
a seat bottom; and
an armrest;
a seat adjuster connected to the seat; and
an adjustable armrest assembly including:
the armrest;
an armrest mount connected to the seat base, the armrest adjustably connected to the armrest mount; and
an armrest adjuster pivotably connected to the armrest, the armrest mount, and the seat bottom;
wherein the seat adjuster includes one or more motors;
wherein the seat adjuster adjusts the seat to a first seat position or to a second seat position via adjusting the seat bottom and the seatback; and
wherein the armrest adjuster simultaneously adjusts the armrest relative to the armrest mount to:
an extended position when the seat adjuster adjusts the seat to the first seat position; and
a retracted position when the seat adjuster adjusts the seat to the second seat position.

15. The seat assembly of claim 14, wherein:
the first seat position is a design position; and
the second seat position is a zero-gravity position.

16. The seat assembly of claim 14, wherein:
the armrest adjuster includes a pivot link, a drive link, and a follow link;
the pivot link is pivotably connected to the armrest mount at or about a link-mount pivot axis;
the pivot link is pivotably connected to the drive link at or about a pivot-drive pivot axis;
the pivot link is pivotably connected to the follow link at or about a pivot-follow pivot axis;
the drive link is pivotably connected to the seat bottom at or about a link-seat pivot axis; and
the follow link is pivotably connected to the armrest at or about a link-armrest pivot axis.

17. The seat assembly of claim 16, wherein the link-mount pivot axis, the link-seat pivot axis, the link-armrest pivot axis, the pivot-drive pivot axis, and the pivot-follow pivot axis extend substantially parallel to one another.

18. The seat assembly of claim 14, wherein:
the armrest includes an armrest frame;
the armrest frame includes an arm support body; and
an orientation of the arm support body relative to the seat base is maintained as the armrest is adjusted from the extended position to the retracted position and is adjusted from the retracted position to the extended position.

19. The seat assembly of claim 18, wherein the arm support body is disposed farther from the seat base when the armrest is disposed in the extended position than when the armrest is disposed in the retracted position.

20. The seat assembly of claim 14, wherein:
the armrest includes a slider; and
the armrest mount includes a guide surface that slidably engages the slider and guides adjustment of the armrest to the extended position or to the retracted position.
